(19) United States
(12) Patent Application Publication
(10) Pub. No.: US 2022/0063123 A1
(43) Pub. Date: Mar. 3, 2022

(54) ULTRA-HIGH PRESSURE PUMP

(71) Applicant: WATERJET CORPORATION S.R.L., MONZA (MB) (IT)

(72) Inventor: Massimo Russo, MONZA (MB) (IT)

(21) Appl. No.: 17/395,504

(22) Filed: Aug. 6, 2021

(30) Foreign Application Priority Data
Aug. 6, 2020 (IT) 102020000019525

(51) Int. Cl. B26F 3/00; B26D 5/00; B26D 5/04; B26D 5/12

(52) U.S. Cl. CPC B26F 3/004; B26D 5/005; B05B 15/72; B26D 5/12; B26D 5/04

(57) ABSTRACT

An ultra-high pressure pump (10) adapted to supply a constant flow of very high-pressure water for the cutting apparatuses of a water-jet and abrasive processing machine, comprising a control unit (15) consisting of a hydraulic pump (15′) connected to a servomotor (15″), a hydraulic switching and compensation unit (16) comprising at least one progressive opening cartridge (16′) and at least one high-speed solenoid valve (16″), a hydraulic accumulator (16′″), a pressure control device (17) and an attenuator unit (18) cooperating with a pressure intensifier unit (14) supplied by means of a low-pressure water circuit (23).

The present invention relates to an ultra-high pressure pump.

More in particular, the present invention relates to an ultra-high pressure pump for supplying a constant flow of very high-pressure water for the cutting apparatuses of a water-jet processing machine with or without the addition of abrasive material.

As is known, water jet technology, used for cutting numerous types of materials, makes use of a very high-pressure water jet up to about 6,500 Bar (typically known as water-jet processing).

Water-jet processing is characterized by easy programming, low cutting costs and the possibility of cutting almost all materials with thicknesses ranging from a few tenths of a millimetre to about 300 mm with a precision of one tenth of a millimetre; for these advantageous features, water-jet cutting has become an essential technology for many types of companies and for different applications.

Currently, with a very thin jet of water of around about 0.1-0.2 mm (millimetres) it is possible to cut materials such as rubber, cork, leather, hide, foam, plastic, wood, etc.; furthermore, by adding a natural abrasive powder to the water, it is possible to cut hard materials such as steel, aluminium, titanium, glass, marble, ceramic, wood, PVC, etc., with thicknesses up to 300 mm.

The pumps for this type of machine generally comprise a piston-cylinder driven in the alternating motion thereof by a hydraulic circuit and pressure intensifying means comprising sources with asynchronous motor rotating constantly or with brushless servomotor, hydraulic pumps with variable flow or fixed-displacement capacity and electro-distribution means comprising overpressure valves functional to the discharge of the line during the switching steps or in stand-by periods.

However, the traditional oil-type intensifier pumps described above have some significant drawbacks related to the fact that they are very noisy and inefficient from an energy savings viewpoint.

Furthermore, the conventional pumps are characterized by another significant disadvantage represented by the fact that they have a high environmental impact due to the considerable amount of oil necessary for actuating the piston cylinder and cooling, which also determines a low energy efficiency of the system (about 70%).

The object of the present invention is to overcome the drawbacks described above.

More in particular, the object of the present invention is to provide an ultra-high pressure pump for water-jet cutting apparatuses adapted to ensure a constant flow of very high-pressure water.

A further object of the present invention is to provide an ultra-high pressure pump which allows to have a continuous control of the pressure for an optimal adjustment of the output value thereof.

A further object of the present invention is to provide an ultra-high pressure pump with considerably reduced noise with reference to traditional pumps.

It is a further object of the present invention to provide an ultra-high pressure pump having a much smaller footprint than the traditional systems thanks to the use of hydraulic components such as pump and reservoir as well as the smaller motor without compromising work performance.

It is a further object of the present invention to provide an ultra-high pressure pump adapted to allow an optimization of oil consumption and which, therefore, is such as to limit, if not reduce, environmental impact problems.

It is a further object of the present invention to provide a more efficient ultra-high pressure pump adapted to ensure high energy savings for the operation thereof and therefore a final cutting processing (and production) cost which is more economical with respect to processing with the traditional pump systems.

It is a further object of the present invention to provide users with an ultra-high pressure pump adapted to ensure high resistance and reliability over time and such as to further be easily and economically made.

These and other objects are achieved by the invention having the features according to claim 1.

According to the invention an ultra-high pressure pump is provided for water-jet cutting apparatuses, adapted to supply a constant flow of very high-pressure water for the cutting apparatuses of a water-jet and abrasive processing machine, comprising a control unit, a switching unit, control devices and an attenuator unit cooperating with a pressure intensifier unit supplied by means of a low pressure circuit connected with said attenuator unit.

Advantageous embodiments of the invention appear from the dependent claims.

The constructive and functional features of the ultra-high pressure pump for water-jet cutting devices of the present invention can be better understood from the following detailed description in which reference is made to the attached drawings which represent a preferred and non-limiting embodiment and in which:

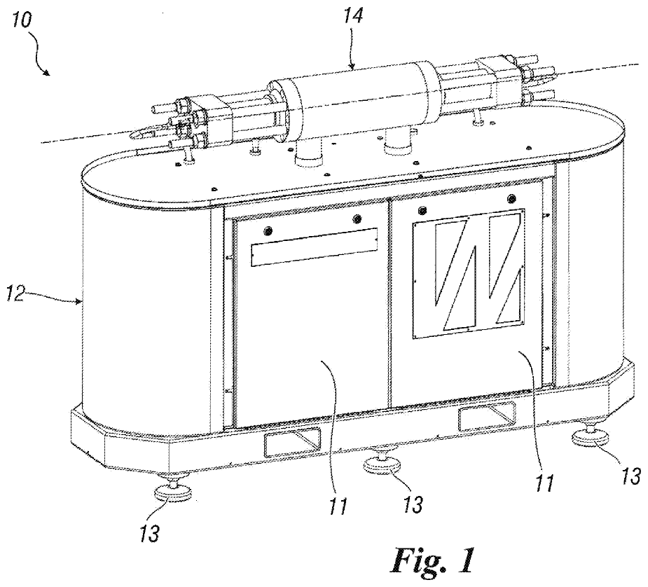

FIG. 1 schematically depicts an axonometric view of an ultra-high pressure pump for water-jet cutting apparatuses of the present invention;

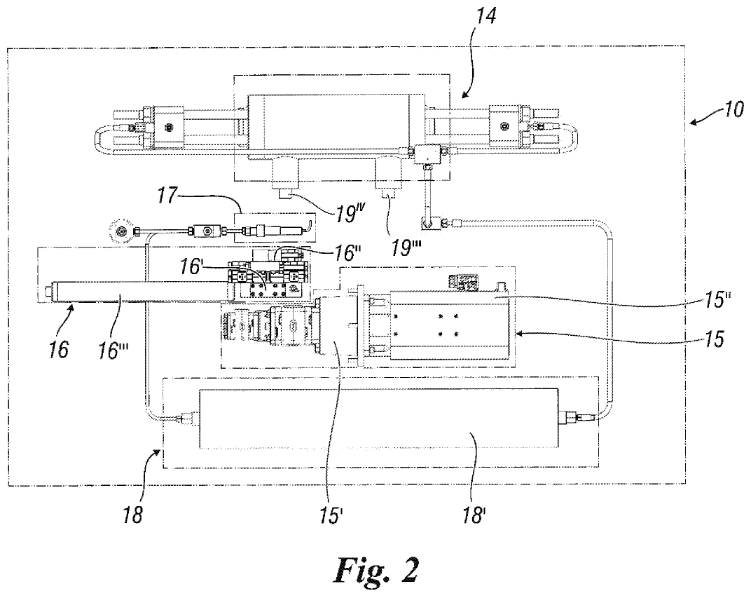

FIG. 2 is a detail of a longitudinal section according to a vertical plane of the pump shown in FIG. 1;

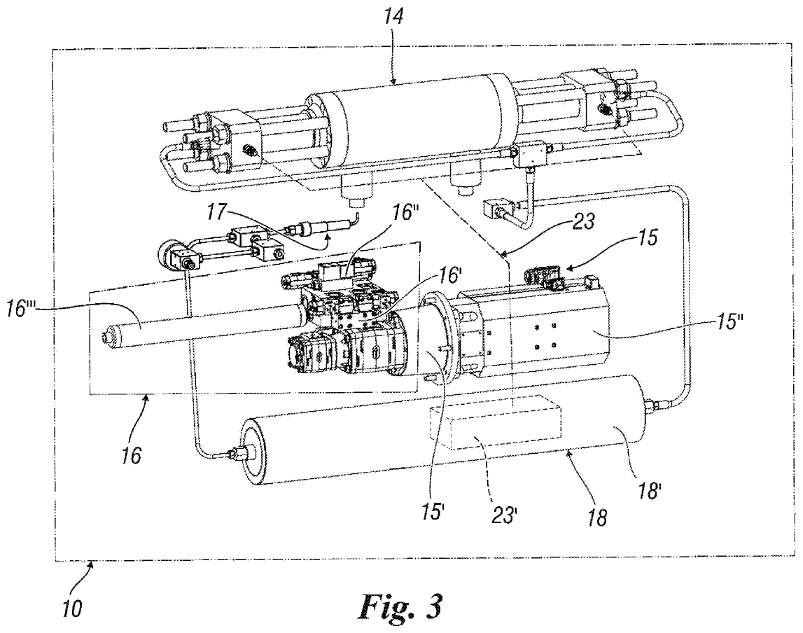

FIG. 3 schematically depicts an axonometric view of the section of FIG. 2;

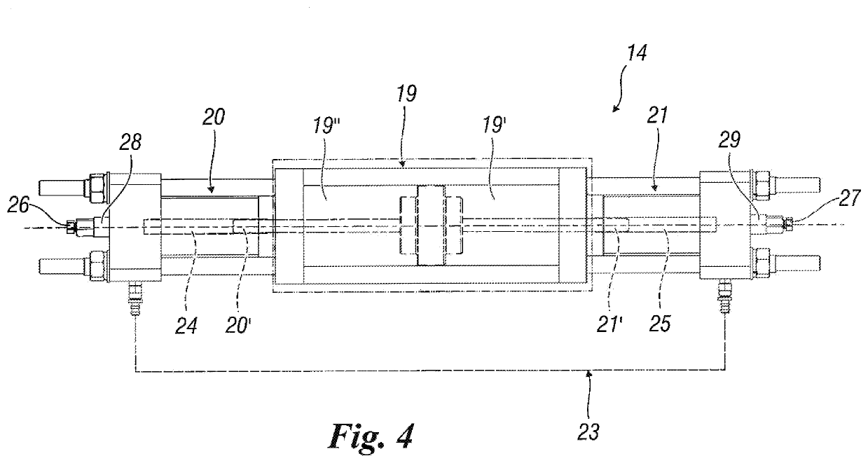

FIG. 4 schematically depicts a top view of a component of the ultra-high pressure intensifier pump of the invention.

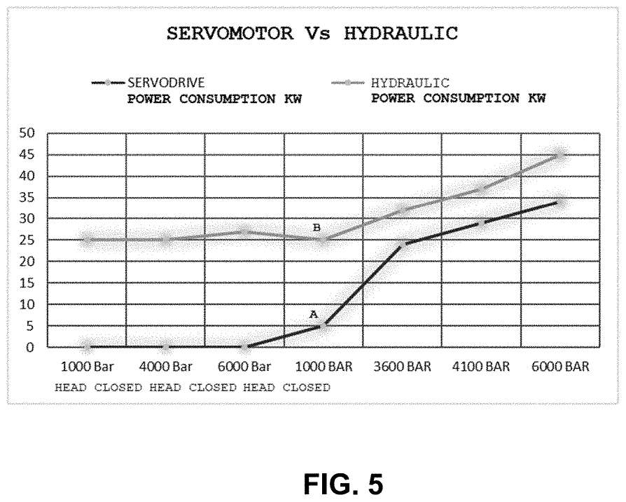

FIG. 5 is a graph that illustrates the improved energy efficiency conditions of the ultra-high pressure pump of the invention.

With reference to the above figures, the ultra-high pressure pump of the present invention is suitable for water-jet cutting apparatuses, indicated as a whole with 10, comprising a machine body 12 defining a container body within which the operating components of the pump of the invention are housed (better described below) and an intensifier unit 14 arranged outside the machine body 12 and adapted to pressurize water, i.e., to intensify or increase water pressure (as is known, the pressurization of water follows the intensification principle/ratio which uses the difference between the piston/plunger area in order to intensify or increase pressure).

The machine body 12 is resting on the ground by means of feet 13 or equivalent support devices and comprises openable doors 11 (of the door or shutter type or similarly suitable for the purpose) to allow inspection, maintenance, repair and the like.

A control unit 15, a hydraulic switching and compensation unit 16, control devices 17 and an attenuator unit 18 cooperating with the intensifier unit 14 are housed inside the machine body 12.

The control unit 15 comprises a high efficiency, fixed-displacement hydraulic pump 15′ and a high variable speed, brushless servomotor 15″, provided with an encoder and connected to said pump for the actuation thereof.

In accordance with an alternative embodiment, the pump may be of single or double displacement type with variable flow rate.

The hydraulic switching and compensation unit 16, connected to the control unit, comprises at least one progressive opening cartridge 16′ (more preferably there are four progressive opening cartridges), at least one fast solenoid valve 16″ which manages in opening/closing said at least one cartridge and one hydraulic compensation accumulator 16′″.

The management of the operation of said hydraulic switching and compensation unit 16 is implemented through a numerical control PLC (Programmable Logic Computer) for the synchronization of the delayed closure of a cartridge 16′ with respect to the opening of another cartridge 16′ in order to prepare the pressurized hydraulic circuit, avoiding shocks and water hammers and ensuring compensation thanks also to the hydraulic compensation accumulator 16′″.

Such synchronized management of the hydraulic switching and compensation unit 16 ensures a reduction in the production of heat to be disposed of and a more constant working pressure, improving the performance of the hydraulic system.

The control devices 17 comprise a continuous pressure detection device adapted to ensure an adjustment of the constant-pressure output value by means of a control of the torque and/or speed of the servomotor 15″ of the control unit 15.

In accordance with an alternative embodiment, an active automatic operation and control on the servomotor can be provided by means of a low and high pressure sensor and/or a read-only passive manual control.

The attenuator unit 18, whose function is to ensure a regularity of the output pressure from the intensifier unit 14, comprises a reservoir 18′ in which pressurized water due to the operation of the intensifier unit 14 is stored. The intensifier unit 14, as indicated above, has the function of pressurizing the water and achieves such a function in accordance with an intensification principle/ratio which uses the difference in the piston/plunger area (better described below) in order to intensify or increase the water pressure.

The intensifier unit 4, better diagrammed in the detail of FIG. 4, comprises a hydraulic cylinder unit 19 comprising a pair of intensifier cylinders opposite each other and defined, respectively, by a first cylinder 20 and a second cylinder 21 which, by means of a first piston 20′ (of the first cylinder 20) and a second piston 21′ (of the second cylinder 21), respectively, direct a constant flow of water towards a cutting head of a water-jet cutting apparatus (not shown in the figure), said first and second pistons being coaxial and arranged according to an axis Y-Y.

The first 20 and the second 21 intensifier cylinder are supplied by means of a low-pressure water circuit 23 of a known type and, therefore, not subject to detailed description.

Such a low-pressure water circuit 23, in FIG. 3 is indicated by the dashed line connecting the intensifier unit 14 with the element 23′ likewise depicted in a dashed line and defining, in a schematic way, the operating means constituting the aforementioned circuit (not described, as known); such a low-pressure water circuit 23 is functional to bring the water into the pumping chambers of the intensifier unit 14, said pumping chambers being defined, respectively, by a first pumping chamber 24 (of the first cylinder 20) and a second pumping chamber 25 (of the second cylinder 21).

At an axial end of the first 24 and the second 25 pumping chamber there are, respectively, a first outlet hole 26 and a second outlet hole 27 from which the pressurized water exits into the pumping chambers 24 and 25; the first outlet hole 26 and the second outlet hole 27 are arranged according to an axial direction (the same axial direction Y-Y of movement of the pistons 20′ and 21′).

At the first hole 26 and the second hole 27 are arranged, respectively, at least a first valve 28 and at least a second valve 29 of the unidirectional type with the function of a non-return valve adapted to prevent a return of the pressurized water, respectively, to the pumping chambers 24 and 25.

The amount of water coming from the low-pressure water circuit 23 is conveyed to the intensifier cylinders (the first cylinder 20 and the second cylinder 21) which, by means of the alternating movement of the first piston 20′ and the second piston 21′ (respectively) and by means of the action of the first unidirectional valve 28 and the second unidirectional valve 29, compress said amount of water through the first hole 26 and the second hole 27, respectively; the pressure of the water flow out of the holes 26 and 27 is a function of the speed and frequency of the alternating motion of the first and second piston according to the axis Y-Y which push the water through a calibrated orifice (not shown in the figures) mounted on a cutting head of a water-jet cutting apparatus.

The servomotor 15″ of the control unit 15 generates the alternating movement of the first piston 20′ and the second piston 21′; said servomotor 15″ transfers the motion to the pistons 20′ and 21′ through a hydraulic circuit defined by the hydraulic switching and compensation unit 16 which transforms the rotary motion of the servomotor into an alternative translational motion of the pistons 20′ and 21′ driven by the hydraulic cylinder unit 19 connected to the hydraulic switching and compensation unit 16 through the hydraulic passages 19′″ of the hydraulic cylinder 19′ and 19^{IV} of the hydraulic cylinder 19″.

In order to ensure a regular output pressure, the attenuator unit 18 achieves a levelling of the pressure oscillations caused by the alternating movement of the first piston 20′ and the second piston 21′.

For this purpose, as described above, the attenuator unit comprises a reservoir 18′ in which water pressurized by the action of the alternating motion of the first 20′ and the second 21′ pistons is stored.

Such pressurized water accumulated in the reservoir 18′ is constantly sent to the cutting head of the water-jet machine (not depicted) since after one of the two pistons 20′/21′ has reached the end-of-stroke position in the respective pumping chamber 24 and 25 it must return (substantially a fraction of a second before the other piston starts its compression action).

As can be seen from the foregoing, the advantages achieved by the ultra-high pressure pump for water-jet cutting apparatuses of the present invention are evident.

The ultra-high pressure pump for water-jet cutting apparatus of the present invention, thanks to the presence of the pump and servomotor unit of the control unit and the hydraulic switching and compensation unit, advantageously allows to limit the discharge of the pump during switching and to turn off the control unit during the stand-by steps (this results in energy consumption savings); in fact, the pump according to the invention, as described, comprises a control unit with a high-efficiency fixed-displacement pump and a high variable speed servomotor and a switching unit which comprises at least one progressive opening cartridge managed by at least one solenoid valve (so as to ensure optimal synchronism in the switching steps and in the movement of the pistons of the intensifier unit).

A further advantage is that the at least one valve of the switching unit is characterized by significantly reduced exchange noise with respect to the known devices and this results in a significant reduction of the overall noise of the pump.

A further advantage is represented by the control devices comprising a continuous pressure sensor device which continuously monitors the pressure which, thanks to the possibility of managing the torque and/or speed of the servomotor of the control unit, allows an optimization of the output water flow (at the cutting head of the water-jet cutting apparatus).

Furthermore, the ultra-high pressure pump of the invention, thanks to the features described, allows to have a cutting apparatus with very high efficiency and equal to about 95% which leads, as a consequence, to further advantages defined by energy savings of about 30% (compared to traditional type devices), reduced noise (less than 78 dB(A)), a reduced amount of oil necessary for the operation of the pump (less than 20 litres) (therefore, less environmental impact for the disposal of waste oil), a reduction in the amount of water for possible cooling.

Further advantageous is the fact that the synchronized management of the switching unit ensures a reduction of heat production to be disposed of and a more constant working pressure, thus improving the performance of the hydraulic system.

As a further demonstration of the advantages of the ultra-high pressure pump of the present invention with respect to the traditional type of pumps (the fully hydraulic type), a table is shown below.

| | ORIFICE | | SERVOMOTOR | HYDRAULIC | |
|---|---|---|---|---|---|
| | DIAMETER | | CONSUMPTION | POWER | |
| | 0.014″-0.35 mm | WORKING | ENERGETIC | CONSUMPTION | ENERGY |
| CONDITION | 3.8 l/min | PRESSURE | KW | KW | SAVINGS |
| Pump ON | Head Closed | 1000 Bar | 0 | 25 | −100% |
| Pump ON | Head Closed | 4000 Bar | 0 | 25 | −100% |
| Pump ON | Head Closed | 6000 Bar | 0 | 27 | −100% |
| Pump ON | Head Open | 1000 Bar | 5 | 25 | −80% |
| Pump ON | Head Open | 3600 Bar | 24 | 32 | −25% |
| Pump ON | Head Open | 4100 Bar | 29 | 37 | −22% |
| Pump ON | Head Open | 6000 Bar | 34 | 45 | −24% |
| | Orifice 0.25 mm | | | | |
| | 2.8 l/min | | | | |

*Values measured with the instrument PMD Energy Monitoring DIRIS A-30

This table compares, for the same working conditions, the pump of the invention and a known type pump and demonstrates the higher energy efficiency of the pump according to the invention (comprising the servomotor) with respect to a traditional type pump (with hydraulic drive). FIG. 5 shows the different and improved energy condition which characterizes the pump of the invention (curve A) with respect to a traditional pump (curve B).

Although the invention has been described with particular reference to an embodiment given merely by way of non-limiting example, numerous modifications and variations will be apparent to a person skilled in the art in the light of the above description. Therefore, the present invention intends to embrace all the modifications and variations which fall within the scope of the following claims.

1. An ultra-high pressure pump (10) suitable for water-jet cutting apparatuses and adapted to supply a constant flow of very high-pressure water for the cutting apparatuses of a water-jet processing machine with or without the addition of abrasive, characterized in that it comprises a control unit (15) comprising a hydraulic pump (15′) connected to a servomotor (15″), a hydraulic switching and compensation unit (16) comprising at least one progressive opening cartridge (16′) and at least one high-speed solenoid valve (16″), a hydraulic accumulator (16″), a control device (17) and an attenuator unit (18) cooperating with a pressure intensifier unit (14) supplied by means of a low-pressure water circuit (23) connected with said attenuating unit (18) and functional to bring the water to said intensifier unit 14.

2. The ultra-high pressure pump according to claim 1, characterized in that in the control unit (15) the hydraulic pump (15′) is of the high-efficiency hydraulic type and with fixed cylinder capacity and the servomotor (15″) is of the brushless type with high variable speed connected to said pump for the actuation thereof.

3. The ultra-high pressure pump according to claim 1, characterized in that the hydraulic switching and compensation unit (16), operatively connected to the control unit (15), comprises at least one progressive opening cartridge (16′), at least one high-speed solenoid valve (16″) and a hydraulic accumulator (16′″).

4. The ultra-high pressure pump according to claim 3, characterized in that there are four progressive opening cartridges (16′) and there are also four high-speed solenoid valves (16″).

5. The ultra-high pressure pump according to claim 3, characterized in that the hydraulic switching and compensation unit (16) is actuated by a numerical-control programmable logic computer (PLC) device.

6. The ultra-high pressure pump according to claim 1, characterized in that the control devices (17) comprise a continuous pressure detection device adapted to ensure an adjustment of the constant-pressure output value by means of a control of the torque and/or speed of the servomotor (15″) of the control unit (15).

7. The ultra-high pressure pump according to claim 1, characterized in that the attenuator unit (18) comprises a reservoir (18′) in which pressurized water is stored by the operation of the intensifier unit (14), said unit being adapted to a levelling of pressure oscillations of the intensifier unit (14) to ensure a regularity of the output pressure.

8. The ultra-high pressure pump according to claim 1, characterized in that the intensifier unit (14) comprises a hydraulic cylinder unit (19) comprising a pair of intensifier cylinders opposite to each other and defined, respectively, by a first cylinder (20) and a second cylinder (21) which, by means of a first piston (20′) (of the first cylinder (20)) and a second piston (21′) (of the second cylinder 21), respectively, direct water with a constant flow towards a cutting head of a water-jet cutting apparatus, with said first (20′) and second (21′) pistons being coaxial.

9. The ultra-high pressure pump according to claim 1, characterized in that the intensifier unit (14) comprises a first pumping chamber (24) inside which the first piston (20′) of the first cylinder (20) is moved and a second pumping chamber (25) inside which the second piston (21′) of the second cylinder (21) is moved, the movement of said first piston (20′) and second piston (21′) being of the alternative type driven by the hydraulic cylinder unit (19) by means of the servomotor (15″) of the control unit (15) and the hydraulic switching and compensation unit (16) which transforms the rotational motion of the servomotor (15″) into an alternative translational motion, the hydraulic cylinder unit (19) being connected to the hydraulic switching and compensation unit (16) by means of hydraulic passages (19′) of a hydraulic cylinder (19′) and (19IV) of the hydraulic cylinder (19″) of the hydraulic cylinder unit (19), the first pumping chamber (24) and the second pumping chamber (25) comprising, respectively, a first outlet hole (26) and a second outlet hole (27) from which pressurized water flows into said pumping chambers (24, 25), said first outlet hole (26) and second outlet hole (27) being arranged according to an axial direction of movement of the pistons (20′, 21′).

10. The ultra-high pressure pump according to claim 9, characterized in that at the first hole (26) and the second hole (27) are arranged, respectively, at least one first valve (28) and at least one second valve (29) of the unidirectional type with the function of a non-return valve adapted to prevent a return of the pressurized water to the pumping chambers (24, 25).
